(19) United States
(12) Patent Application Publication
(10) Pub. No.: US 2003/0110127 A1
(43) Pub. Date: Jun. 12, 2003

(54) Systems and methods for conveying common law estates in property using disregarded entities

(76) Inventor: Richard J. Sabella, New York, NY (US)

Correspondence Address: BUCKLEY, MASCHOFF, TALWALKAR, & ALLISON, 5 ELM STREET, NEW CANAAN, CT, 06840, US

(21) Appl. No.: 10/134,586

(22) Filed: Apr. 29, 2002

Related U.S. Application Data
(60) Provisional application No. 60/339,207, filed on Dec. 11, 2001.

(51) Int. Cl. G06F 17/60

(52) U.S. Cl. 705/39

(57) ABSTRACT

Systems, methods, apparatus, mediums and means for creating or transferring the functional and tax equivalent of an interest, particularly a common law estate, in an asset owned by a first entity are provided where the first entity is obligated to obtain consent from a lender or other party if the asset or an interest therein is conveyed to a third party or where the creation or transfer of a common law estate in such asset directly would entail significant cost. A disregarded entity is formed holding the first entity's rights in the asset. In lieu of a transfer of rights or a common law estate in such asset directly, there is conveyed rights or such common law estate in the equity interests in such disregarded entity, wherein such transfer does not require any such consent and does not involve the high cost traditionally associated with common law estate transactions.

### CROSS-REFERENCE TO RELATED APPLICATIONS

This application hereby claims priority to and the benefit of U.S Provisional Patent Application Serial No. 60/339,207 filed on Dec. 11, 2001, the subject matter and content of which is hereby incorporated by reference herein for all purposes.

### FIELD

The present invention relates to the conveyances of interests, particularly common law estates in property. In particular, some embodiments of the present invention relate to systems and methods for conveying common law estates in the equity interests of a company that qualifies under current tax law as a “disregarded entity”, and thereby creating, for U.S. tax purposes, a corresponding common law estate in the assets of the disregarded entity.

### BACKGROUND

Real estate and other property conveyancing techniques have remained substantially unchanged for years. Purchasers, sellers, and lenders enter into transactions that allow the purchaser to acquire property owned by the seller and that allow lenders to receive a secured position in exchange for loaned funds. The most common type of property conveyance is the transfer of the “fee simple” estate in the subject property. Essentially, a fee simple conveyance is a transfer of all the economic and beneficial rights in the subject property for all time. Other interests or estates in property may also be transferred.

For example, one may create a remainder estate in property for conveyance to another. The remainder interest will “vest in possession” at a future time set forth in the instrument of conveyance. Prior to the date of vesting, the transferor, as the owner of a retained “term” or “life” interest in the property, will have the exclusive right to possess and exploit the subject property (in the same manner as would a fee simple owner thereof), subject only to certain relatively limited common law duties to the owner of the remainder estate. These duties may include, among others, the duty to preserve the subject property for the benefit of the remainder holder and not to commit waste. At the date of vesting of the remainder estate, the transferor's interest and estate in the property automatically terminates and the owner of the remainder estate becomes the fee simple owner of the property.

Property interests such as the remainder, life and term estates referred to above are typically described as “common law estates” because they derive from the English common law of property. Applicant believes that common law estates of the types described above are recognized in all fifty states in the United States. Such estates may take various forms and be subject to any number of conditions or contingencies.

Common law estates have tax and economic characteristics that differ substantially from those applicable to fee simple interests. For example, a term of years interest can have significantly greater tax benefits than ownership of the fee simple interest in the same property; remainder interests in general may have little or no tax benefits compared to fee simple ownership. The availability of low cost debt financing, which is fairly common in the case of fee simple investments, is rarely available for the holder of a common law estate investment. In addition, the transaction costs to create and finance common law estates, as well as to transfer a common law estate, can be prohibitive in all but the largest transactions. It would be desirable to provide systems and methods that reduce transaction costs associated with the creation, financing or transfer of common law estates.

Common law estates have been used as tax enhanced investments. For example, the real estate and equipment leasing communities have used common law term estates as devices to allow an investor to control significant assets and to generate tax benefits that compare favorably with those that would have been available in respect of a fee simple investment in the same assets. As a more particular example, in the real estate area, a common type of property transaction (a single tenant net lease or “STNL” transaction) involves the purchase of the fee simple estate in property net leased to a commercial tenant on a long-term basis. Generally, STNL transactions are “leveraged” with a third party mortgage loan, which is repaid in periodic installments funded from the rents payable by the commercial tenant. Investors that are interested in STNL transactions often desire to enjoy an annual tax deduction from ownership while preserving or increasing equity and/or receiving periodic rent payments.

Typically, STNL transactions have significant tax benefits in the early years of their existence. Unfortunately, however, it is also typical for STNL transactions to cease generating tax benefits after a period of time. A principal reason that the tax benefits decline or abate is that the largest source of tax benefit in STNL transactions derives from mortgage interest payments, all of which are tax deductible as ordinary business expenses of the owner of the property. In the typical STNL mortgage loan, interest payments are greatest in the early years of the investment and, as time progresses, principal payments increase and interest payments decrease.

The result of this process of debt repayment is the gradual diminishment of tax deductions and the increase of taxable income generated by the investment. In many cases, these types of investments will eventually generate so-called “phantom income” or tax costs to the owner without any actual cash payments. Often, in the case of STNL transactions, phantom income can arise after 3-5 years of holding a property. Phantom income can cause property owners to dispose of a property to avoid recognizing net positive income from the property.

The purchase of a term estate instead of a fee simple estate in a particular property can result in the postponement of phantom income generation for a substantial period of time. Generally, this postponement function is the result of a shorter cost recovery period being applicable to the term estate than to the corresponding fee interest. Most fee simple realty investments are depreciated over a period of approximately 40 years. In addition, U.S. tax laws do not allow any tax recovery deductions in respect of that portion of any realty investment that constitutes a fee simple interest in land. By comparison, a term interest in leased real estate, including the land portion of the investment, may be amortized on a straight-line basis over the term of the estate. Thus, a 20-year term estate valued at $1,000,000 will generate an annual cost recovery deduction of $50,000. The same realty owned in fee simple will generate only $20,000 of cost recovery or depreciation deductions annually (assuming that 20% of the entire investment value is attributed to land cost). For this reason, tax sensitive realty investors often seek to purchase term estates instead of fee simple investments.

Unfortunately, however, the availability of term investments having the tax characteristics mentioned above is quite limited. The dearth of these types of investments is the result of the higher cost and greater complexity of mortgage financing associated with term investments and common law estate transactions generally. Except in the largest transactions, the greater transaction cost and complexity in creating common law estates in STNL and other transactions and coordinating the rights of the mortgage lender with those of the common law estate owners has outweighed the substantial tax benefits that otherwise would be available in the common law estate structure. It would be desirable to provide systems and methods that preserve all the tax and economic advantages of a common law estate investment while eliminating many, if not all, of the costly impediments to the creation and financing of common law estates that have historically existed.

Further, purchasers who acquire real estate wish to reduce the cost of acquiring a property. The cost to acquire property can include one time or non-recurring costs associated with conveying the property. For example, these costs can include attorney fees associated with drafting and negotiating mortgages and real estate contracts or consent agreements or legal opinions associated with the transfer of realty assets. Often, the attorney, appraisal, inspection, title insurance and accounting fees associated with a particular transaction can render the transaction unprofitable. These costs can be very substantial (in relation to the amount of an investor's cash investment) in the case of STNL transactions that involve the sale of a property that is already subject to a substantial loan. In many cases realty investors will purchase properties with loans in place that represent as much as 95% of the total value of the realty. Thus, for example, a STNL investor might purchase a $1,000,000 asset with an equity payment of only $50,000. In such a case, the legal fees and other transaction expenses to convey the investment could easily exceed the cash investment amount. These costs are, under the current state of the art, even more prohibitive in the case of common law estate transactions because of the inherent complexity of common law estate investments. It would be desirable to provide conveyancing techniques that reduce non-recurring costs associated with transferring property in general and common law estates in particular.

An example of a type of transaction which can entail large non-recurring transaction costs will be described by reference to FIG. 1. The example transaction 10 of FIG. 1 involves several participants: a purchaser 12, a seller 14 and a lender 18. In the example transaction, seller 14 owns title to an asset 16 (which may be, for example, real property or the like), and the parties desire to enter into a transaction to convey a common law estate in asset 16 to purchaser 12. In the example transaction 10 (as is frequently the case in many transactions) the seller's interest in the asset 16 is encumbered by a mortgage from lender 18. The mortgage from lender 18 required seller 14 to agree to comply with a number of terms in exchange for funds.

One common contractual obligation included in most mortgages or property loans is a requirement that any conveyance of title to the property or a common law estate therein by the seller be subject to the written consent of the lender. Thus, in order to complete the example transaction 10 depicted in FIG. 1, purchaser 12 and seller 14 must secure written consent from lender 18. Many lenders will simply refuse to permit a splitting of their collateral property into several common law estates; those that will consider allowing such a split invariably insist on the wholesale revision of the loan contract and the payment of substantial fees as well as legal opinions, instruments of assurance and other binding agreements from the purchaser. It can be difficult, time consuming and expensive to obtain these consents.

In many situations, a property such as a STNL property may be burdened by several mortgages, leases or management contracts, each of which requires some consent from the lender or other counterparty prior to a transfer of a common law estate to a purchaser. In such situations, the purchaser (and/or the seller) may expend a large amount of funds and time on legal fees or consent payments attempting to secure consents from each of the lenders and other counterparties. Frequently, these efforts are unsuccessful or are thwarted by the prohibitive cost of compliance with the lender's or other counterparties' requirements. Further, each of the lenders or other interested parties may require different or inconsistent conditions before providing a consent.

It would be desirable to provide methods and systems that reduce or eliminate the need for any lender or other consents in the case of the creation of a common law estate (or the functional and tax equivalent thereof) in encumbered property, thereby reducing some of the non-recurring costs associated with a particular transaction, thereby increasing the potential return to a purchaser.

### SUMMARY

To alleviate problems inherent in the prior art, the present invention introduces systems, methods, apparatus, mediums, and means for transferring common law estates and interests in property, particularly encumbered property, though the use of one or more disregarded entities.

Pursuant to some embodiments of the present invention, systems, methods, apparatus, mediums and means are provided for transferring a common law estate in an asset owned by a first entity, wherein said first entity is obligated to obtain a consent from an interested party if the asset, or any interest or estate therein, is conveyed to a third party. Processing includes forming a disregarded entity holding the first entity's rights in the asset, and then transferring a common law estate in the equity interests of such disregarded entity to a subsequent purchaser, wherein the subsequent purchaser acquires the functional and tax equivalent of a common law estate in the asset, and wherein the transfer does not require consent from any interested party.

In some embodiments, the first entity is initially converted to a disregarded entity or the asset is transferred to a newly created disregarded entity (the “Ownerco Entity”). Next, the entirety of the equity interests in the Ownerco Entity are transferred to a newly created disregarded entity (the “Holdingco Entity”), thereby causing the owner of the Holdingco Entity to be regarded, for U.S. tax purposes, as the owner of the asset held by the Ownerco Entity. Such owner now creates and transfers to a third party for value a common law estate in the equity interests in the Holdingco Entity. Pursuant to some embodiments of the present invention, the terms, conditions and covenants of the common law estate thus created are such as to be the tax and functional equivalent for all material purposes of the creation of a similar common law estate directly in the underlying asset of the Ownerco Entity.

Pursuant to various embodiments of the present invention, (1) further disregarded entities are formed to hold rights to the Ownerco Entity or the Holdingco Entity, (2) the form of disregarded entity utilized for the invention is a limited liability company or a business trust, and (3) methods, apparatus, mediums and means for transferring an asset owned by an Ownerco Entity are provided wherein an Ownerco Entity that is obligated in its mortgage loan contract to obtain a consent from a lender if the asset or a common law estate therein is conveyed to a third party and the transferring of the functional and tax equivalent of such an estate is accomplished without obtaining such a consent and without violating the terms of applicable mortgage agreement.

Applicant has discovered that use of embodiments of the present invention to create the tax and functional equivalent of a common law estate in a subject asset results in numerous efficiencies. Applicant believes that some of these efficiencies arise because, for all purposes other than U.S. tax treatment, an Ownerco Entity established pursuant to embodiments of the present invention is regarded as the fee simple owner of the subject asset. Accordingly, pursuant to some embodiments of the present invention, mortgage financing may be incurred at the Ownerco Entity level without the above-described complexity and extra expense associated with transfers of common law estates. In addition, numerous other parties that may have interests in the underlying asset, such as tenants, insurers and local taxing authorities also “see” only the fee simple ownership of the asset by the Ownerco Entity, thereby eliminating costly contractual arrangements that otherwise would have to exist to coordinate the rights of all interested parties in and to the subject asset with those of the common law estate holders.

Similarly, embodiments of the present invention can dramatically reduce or eliminate the costs of obtaining lender or other consents to the transfer of a common law estate in a STNL or other property transaction. Such a reduction or elimination is possible because, for purposes of many commercial mortgage agreements, the use of embodiments of the present invention does not constitute a transfer that is prohibited by the mortgage agreement inasmuch as the actual borrower of the loan, the Ownerco Entity, has not changed or otherwise been affected by the transaction. Applicant has found that use of embodiments of the present invention permit transfers of estates at substantially lower transaction costs than was previously possible.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a transaction flow diagram illustrating a typical real estate transaction involving a transfer of a common law estate in an asset to a purchaser for value;

FIG. 2 is a transaction flow diagram illustrating a transfer of the functional and tax equivalent of a common law estate in an asset using disregarded entities according to one embodiment of the present invention;

FIG. 3 is a transaction flow diagram illustrating a transfer of the functional and tax equivalent of a common law estate in an asset using disregarded entities according to another embodiment of the present invention;

FIG. 4 is a flow chart of a transaction method pursuant to some embodiments of the present invention;

FIG. 5 is a flow chart of a further transaction method pursuant to some embodiments of the present invention; and

FIG. 6 is a block diagram depicting a transaction device for use in evaluating and conducting transactions pursuant to some embodiments of the present invention.

### DETAILED DESCRIPTION

Embodiments of the present invention relate to transaction methods and systems for the transfer of common law estates in “assets””. As used herein, the term “asset” is used to refer to rights in any type of tangible or intangible asset. Throughout the remainder of this disclosure, examples will be given primarily focusing on real property transfers; however, upon reading this disclosure, those skilled in the art will recognize that features of embodiments of the present invention may be used to transfer rights in other types of property, such as, for example, personal property, fixtures, intangible assets or the like.

Embodiments of the present invention utilize the recently recognized tax concept of the “disregarded entity” to create interests that are regarded for tax purposes as common law estates in assets owned by the disregarded entity. For state law (nontax) purposes, the estate that is created by use of the instant invention is an interest in the equity securities of the disregarded entity. Under prevailing tax laws, the ownership of the “disregarded entity” is treated as nonexistent and is ignored, with the result that the tax authorities construe the common law estate in the equity securities of the disregarded entity as tantamount to a common law estate in the underlying assets of the disregarded entity.

As used herein, the term “disregarded entity” is used to refer to entities governed by Sections 301.7701-1 through 301.7701-3 of the U.S. Federal Income Tax code. Pursuant to those sections, certain organizations that have a single owner can choose to be recognized or disregarded as entities separate from their owners. As used herein, an entity which is a “disregarded entity” is an entity whose activities, for federal income tax purposes, are treated in the same manner as a sole proprietorship, branch or division of the owner. Applicant has found that single-member limited liability companies and business trusts, when properly formed, provide desirable benefits when used in conjunction with embodiments of the present invention. Applicant has recognized that treatment as a disregarded entity, in conjunction with other features of embodiments of the present invention, achieves desirable results when used to conduct property transactions, particularly common law estate transfers, pursuant to embodiments of the present invention.

As used herein, the term “lender” will be used to refer to an individual or entity (or its agent or designee) which provides funds to an entity on certain terms (e.g., via a mortgage or other contractual document). As used herein, the term “purchaser” will be used to refer to an individual or entity (or its agent or designee) which provides funds or other consideration to a seller in exchange for an interest in an asset (e.g., such as title to real property). As used herein, the term “seller” will be used to refer to an individual or entity (or its agent or designee) which conveys interest in an asset (e.g., such as title to real property) to a purchaser in exchange for funds or other consideration. Some or all of the entities described herein may be formed as disregarded entities. Unless otherwise noted herein, some or all the entities described herein may be formed as other types of entities (e.g., partnership, trust, corporation, etc.).

According to some embodiments of the present invention, a disregarded entity is established to hold title to the realty or asset. Further, the disregarded entity is structured and caused to act as the owner and “borrower” under any mortgage loan facility associated with the realty or asset. Applicant has discovered that the use of the disregarded entity as the borrower satisfies all the objectives of the lender in that the entity is fully recognized as a person capable of owning property and entering into contracts pursuant to the applicable state law.

Pursuant to some embodiments of the present invention, the owner of the equity securities in the disregarded entity conveys an equivalent of a common law estate in such equity securities (or, the owner of the equity securities of another disregarded entity that owns the equity securities of the borrower entity is caused to convey such an estate). In some embodiments, these transfers occur in respect of disregarded entities that own assets subject to existing secured loan facilities. As used herein, the “equivalent” of the common law estate transferred is a functional and tax equivalent of a common law estate in the asset.

Applicant has discovered that use of this structure in lieu of a direct transfer of a common law estate in the subject asset often obviates the need for any consents or payments that otherwise might be required under loan agreements, leases or other material agreements relating to the underlying asset and leads to efficiencies in the creation or transfer of the common law estates and coordinating the rights of the various parties to the transaction. Embodiments of the present invention, for example, allow local real estate taxation to be simplified (because there is reflected in the public record only one owner of the property, the disregarded entity). Embodiments of the present invention further allow both common law estate holders to share the benefits of a single title insurance policy and any other assets related to the use and enjoyment of the realty that are owned by the borrower entity (such as casualty and liability insurance or easement rights).

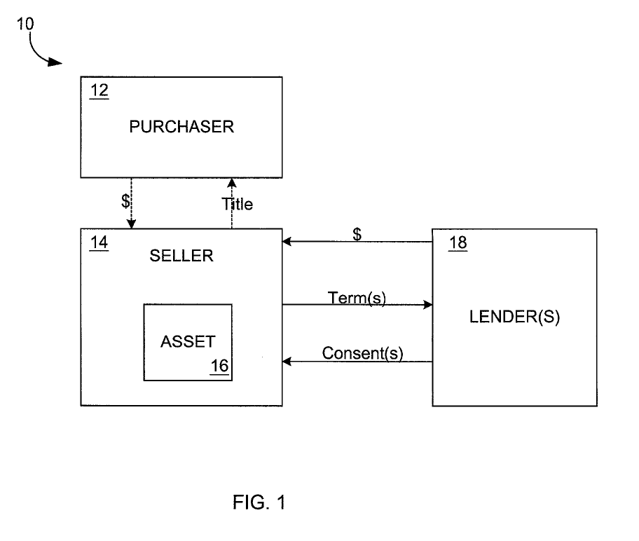

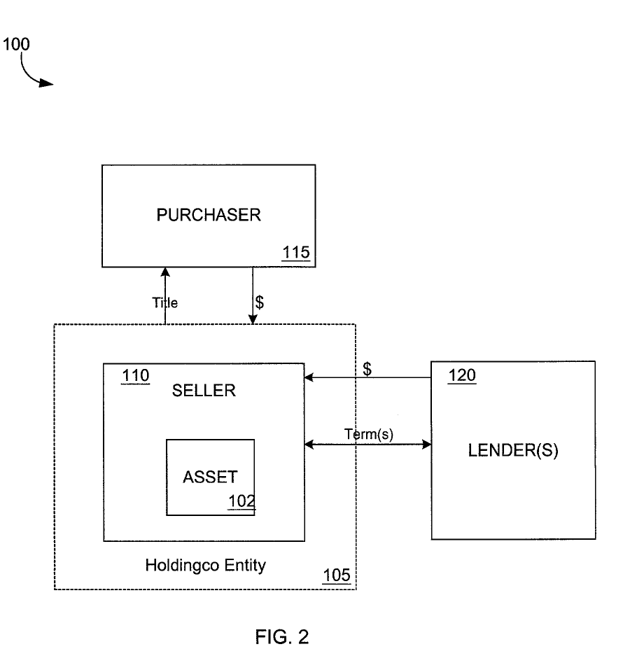

Turning now in detail to the drawings, FIG. 2 is a transaction flow diagram 100 according to some embodiments of the present invention. As depicted by the transaction flow of FIG. 1, certain transactions pursuant to embodiments of the present invention involve a seller 110 that owns title to an asset 102. In certain preferred embodiments, asset 102 is real property although those skilled in the art, upon reading this disclosure, will recognize that other assets may also be conveyed using techniques of the present invention.

As depicted, seller 110 has one or more mortgages or loans from one or more lender(s) 120. For funds from each of the lender(s) 120, seller 110 agreed to comply with certain terms. As is typical in the industry, the terms may include terms restricting seller 110 from conveying the property or any interest therein (including the creation and transfer of a common law estate) without consent from the lender. Pursuant to some embodiments of the present invention, seller 110 or the owner of seller 110 may convey the tax and functional equivalent of the asset 102 or a common law estate therein efficiently and often without securing consents from each lender or any other interested person.

In some embodiments, this is performed by converting seller 110 to a disregarded entity (if seller 110 is not already such an entity). For the purposes of describing features of the present invention, this converted entity may be referred to herein as the “Ownerco Entity”. The transfer of common law estates further includes the formation of a further disregarded entity to hold equity interests of the Ownerco Entity. For the purposes of describing featues of embodiments of the present invention, this further disregarded entity may be referred to herein as “Holdingco Entity 105”. Holdingco Entity 105 is formed such that it receives or owns all the equity interests in seller 110 (or the “Ownerco Entity”), including equitable ownership of asset 102. According to some embodiments of the present invention, Holdingco Entity 105 is also disregarded entity. Following any such conversion and the formation of Holdingco Entity 105 as discussed above, seller 110 or Holdingco Entity 105 may be a single member limited liability company or a business trust. In this manner, both seller 110 (or the “Ownerco Entity”) and Holdingco Entity105 are disregarded for tax purposes.

Further, Applicant has discovered that such a structure allows (1) the owner of all the equity interests in Holdingco Entity 105 (i.e., the same person that was the original owner of the equity interests in seller 110) to convey to a purchaser for value interests (including, in particular, common law estates) in the equity securities of Holdingco Entity 105 or (2) Holdingco Entity 105 to convey to a purchaser for value interests (including, in particular, common law estates) in the equity securities of seller 110. In either such case, because of the use of disregarded entities in the ownership structure pursuant to the instant invention, the interests so conveyed are the functional and tax equivalents of common law estates in asset 102. Also, in either such case, the conveyances are accomplished without the need to secure consents from lender(s) 120 or other persons having an interest in asset 102 and with less transaction and other cost typically associated with a common law estate transaction.

Accordingly, the functional and tax equivalent of an interest in asset 102, particularly a common law estate therein, may be conveyed by the owner of Holdingco Entity 105 to a purchaser 115 without consents from lender(s) 120 or others. By utilizing the instant invention as described above, transaction participants and investors can reduce many of the non-recurring costs associated with common real estate and common law estate transactions. In particular, Applicant has discovered that a great deal of legal expense and fees usually associated with the creation, financing and transfer of common law estates in property can be avoided through use of this technique.

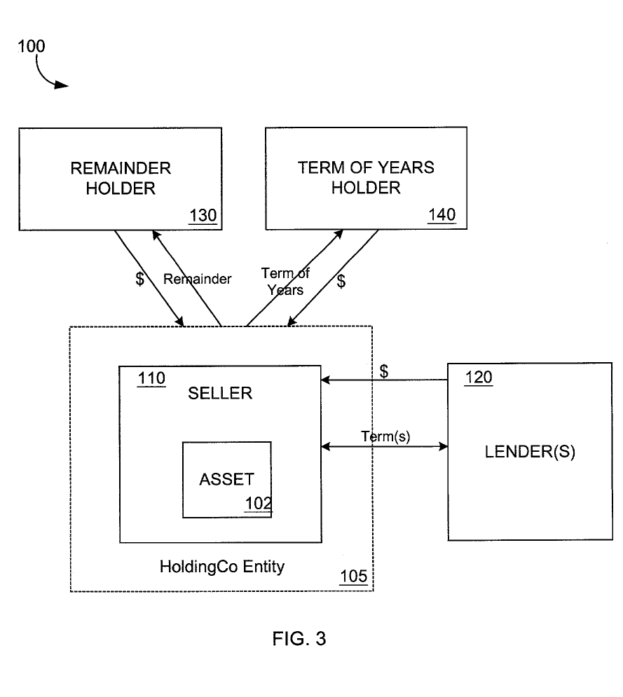

Further advantages can be obtained in a structure such as the transaction structure depicted in FIG. 3. As depicted in FIG. 3, a real estate transaction 102 pursuant to some embodiments of the present invention involves a seller 110 which owns an asset 102 (e.g., such as a piece of real property). The seller 110 is contractually obligated to one or more lender(s) 120 that provided funds to the seller. Some or all of the lender(s) may require written consent prior to a conveyance of the asset 102 or any interest or estate therein by the seller.

Pursuant to some embodiments of the present invention, the owner of the equity interests in seller 110 converts seller 110 to a disregarded entity (if seller 110 is not already such an entity) and forms a Holdingco Entity 105 that is formed and held as a disregarded entity. For example, Holdingco Entity 105 may be formed as a single member limited liability company or business trust having only a single beneficiary. By virtue of the ownership relationships thus created, for tax and other purposes, Holdingco Entity 105 owns equitable title to asset 102 and to all other assets of seller 110.

Pursuant to some embodiments of the present invention, Holdingco 105 transfers interests in the equity interests in seller 110 (which transfers are the functional and tax equivalent of like transfers of asset 102) to one or more purchasing entities. In particular, as depicted in the transaction structure of FIG. 3, Holdingco 105 transfers a future interest (such as a remainder interest) in the equity interests of seller 110 to a remainder holder 130 and a present possessory interest (such as a term of years interest) in the equity interests of seller 110 to a term of years holder 140. These transfers, by virtue of the instant invention, are the functional and tax equivalents, respectively, of a transfer of a remainder interest in asset 102 to the first purchaser 130 referred to above and a transfer of a term of years interest in asset 102 to the second purchaser 140 referred to above. In exchange for both of these transfers, Holdingco Entity 105 receives consideration. Pursuant to some embodiments of the present invention, Holdingco Entity 105 may receive greater consideration for the transfer of the future interest and the present possessory interest than it would if it had transferred or caused seller 110 to transfer fee simple title of the asset 102 outright to a single purchaser. Features of such a fractionalization of interests are further described in U.S. Patent Application Serial No. 60/339,207 filed on Dec. 11, 2001 by the Applicant.

In addition to the two fractionalized interests in the asset, the transaction depicted in FIG. 3 may also include the grant of a recombination right to term of years holder 140 which allows holder 140 to combine the two interests into a fee simple estate. For example, the recombination right may be an option to acquire the residual interest granted to remainder holder 130. In some embodiments, the terms of the first and second fractional interests, as well as the terms of the recombination right, are established and priced to provide a number of different scenarios. The participants can then select the scenario that satisfies their desired level of risk and return.

As an example, Holdingco Entity 105 may transfer a 10 year term of years interest to term of years holder 140 and a remainder interest to remainder holder 130, granting the remainder holder a fee simple interest in the asset at the end of the 10 year term of years interest. Holdingco Entity 105 may further transfer a recombination right (such as an option) to holder 140 allowing holder 140 to recombine the two interests into a single estate upon exercise of an option during the term of years interest. In this manner, Holdingco Entity 105 and/or seller 110 may realize a potentially greater value for the asset 102 than it may have realized in an outright sale of the asset. Further, advantageous benefits accrue to both the remainder holder and the term of years holder. For example, remainder holder 130 may acquire a future interest to value property for a relatively low price and may enjoy the ability to convey the asset at a predetermined price if term of years holder 140 exercises the option. Term of years holder 140 enjoys present possessory rights to the asset 102 and further enjoys advantageous tax treatment (e.g., such as the ability to amortize the cost of the term of years interest over a shorter period than he would otherwise be entitled to if he took full title to the property (e.g., fee simple).

According to some embodiments of the present invention, the total amount of consideration received by Holdingco Entity 105 is approximately equal to or greater than the market value of the asset. As a result, from the perspective of a seller, sale of a property or the functional and tax equivalent thereof pursuant to the instant invention is at least as desirable as sale of a property using traditional conveyancing techniques. Further, using a disregarded entity such as Holdingco Entity 105 allows the transaction to occur without costly and time consuming consents from lender(s) and other interested parties.

From the perspective of term of years holder 140 and remainder holder 130, acquisition of a property interest, particularly a common law estate in property (or the functional and tax equivalent thereof using techniques of the present invention) is preferable to acquisition using traditional financing and conveyancing techniques as a result of improved tax treatment, pricing, and flexibility. Further, by appropriately structuring and pricing a recombination right, term of years holder 140 may achieve a desired return on its original investment and the advantages in respect thereof.

Once the disregarded entity or entities have been established and the functional and tax equivalent of the property conveyed using common law estates and a recombination right, the interests are held according to their terms. For example, in an embodiment where term of years holder 140 acquired a term of years interest having a duration of 10 years, the recombination right may be an option to acquire the residual interest of remainder holder 130 at the end of the 10 year term or at specified times prior thereto. If term of years holder 140 chooses to exercise this option, an agreed upon or formula based price (agreed at the time the option and common law estates are created) must be paid by term of years holder 140 to remainder holder 130 to exercise the option. Upon exercising the option, term of years holder 140 acquires title to the disregarded entity that owns the property (e.g., ownership in fee simple absolute of all the equity interests in the disregarded entity that owns the asset ). If term of years holder 140 elects not to exercise the option, it may sell or otherwise convey the option to a third party. If the option is not exercised, title to the property vests in remainder holder 130. The result is a transaction system and method which provides desirable tax, financial, risk, and flexibility benefits to each participant. Pursuant to some embodiments of the present invention, the resulting transfer of rights provides a number of benefits to participants to the transaction, including, but not limited to, a greater gross recovery to the seller and its equity owners, a reduced tax impact on the remainder holder 130 and term of years holder 140, and improved bankruptcy protection to both the remainder holder and the term of years holder.

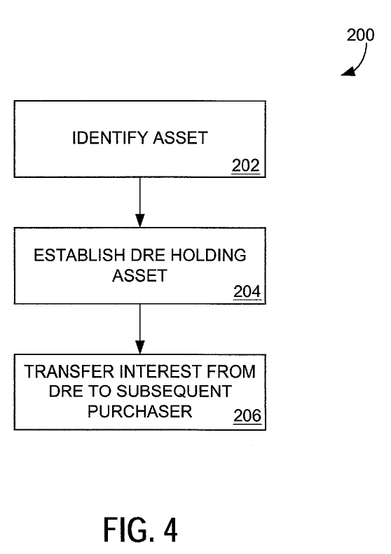

Reference is now made to FIG. 4, where a flow diagram depicting a transaction method pursuant to some embodiments of the present invention is shown. The transaction method 200 of FIG. 4 may be performed by, or on behalf of (for example) a holder of an asset to facilitate the transfer of the asset utilizing features of embodiments of the present invention.

Processing begins at 202 where the asset to be transferred is identified. For example, processing at 202 may include the identification of both the asset and rights and obligations associated with the asset (e.g., such as mortgages, leases, etc.) which affect the value of the asset. Processing continues at 204 where one or more disregarded entities holding the asset are established. Pursuant to some embodiments of the present invention, multiple disregarded entities may be formed if necessary to comply with the covenants of loan documents, leases, management contracts, insurance policies or other obligations relating to the asset 202.

Processing continues at 206 where an owner of the equity securities of the disregarded entity conveys an interest in the ownership of such equity securities, particularly a common law estate, to a purchaser for value. For example, the conveyance at 206 may include the conveyance of a remainder estate or a term of years estate in the equity securities established at 204. The result is the transfer of ownership interest in the asset without the need to seek consents from lenders or other parties associated with the asset. Further, use of transaction method 200 provides desirable tax advantages and reduces many of the costs associated with the transfer of assets such as real estate.

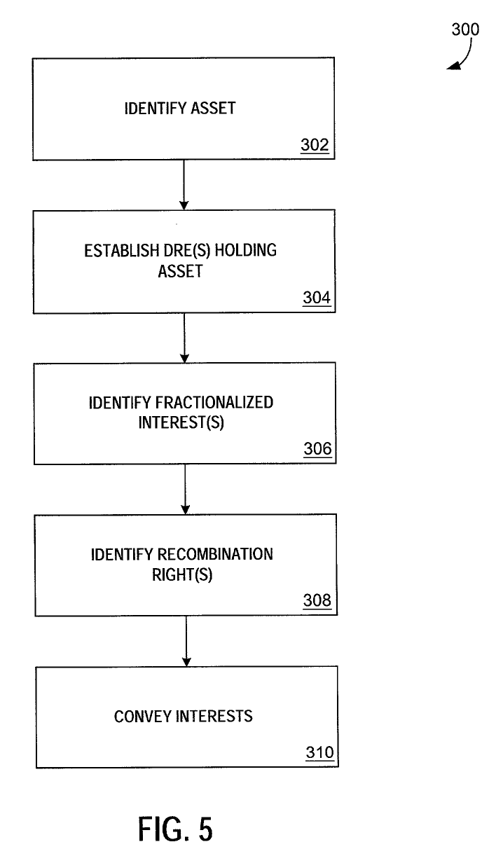

A further transaction method 300 pursuant to some embodiments of the present invention will now be described by referring to FIG. 5. As shown in FIG. 5, transaction method 300 includes the conveyance of one or more common law estates as well as one or more recombination right(s) providing further beneficial advantages to participants to a transaction.

Processing begins at 302 where the asset to be transferred is identified. Processing continues at 304 where one or more disregarded entities are established to hold the asset. Transaction method 300 further includes processing at 306 where one or more fractionalized interest(s) are identified.

The fractionalized interest(s) created at 306 may be created using techniques as mentioned above in conjunction with FIG. 3 and as described in U.S. Patent Application Serial No. 60/339,207 which is incorporated herein by reference. In one embodiment, two fractionalized interests are identified at 306: a term of years interest and a remainder interest. The term of years interest may be conveyed to one party and the remainder interest may be conveyed to a second party. The term of years interest gives the holder a present possessory interest in the asset for an agreed-upon term of years. The remainder interest provides the holder with a future interest in the asset (e.g., the right to a possessory interest at the end of the term of years interest).

Pursuant to some embodiments of the present invention, a recombination right may also be identified (at 308). In some embodiments, this recombination right is granted to an investor providing the investor with an option to acquire the remainder interest identified and granted at 306. In some embodiments, the terms of the common law estates, as well as the terms of the recombination right, are established and priced to provide a number of different scenarios. The participants can then select the scenario that satisfies their desired level of risk and return. Once the parties have identified the desired fractionalized interest(s) and recombination right(s), processing continues at 310 where the interests are conveyed. Because the interests are conveyed from a disregarded entity established at 304, a number of desirable advantages accrue to the parties, including reduced transaction costs, improved tax benefits, and other advantages described herein.

Further, because transaction method 300 includes the creation of one or more fractional interests pursuant to some embodiments of the present invention, additional advantages accrue to the parties. For example, the seller will realize a return equal to or greater than an outright sale of the asset. The party receiving the term of years interest enjoys use of the property at a reduced price while further enjoying a larger cost recovery deduction than would be possible if the asset were transferred outright. As a result, in many cases, the term of years holder will avoid phantom income for a longer period than was previously possible. The party receiving the future interest enjoys a predictable investment rate of return.

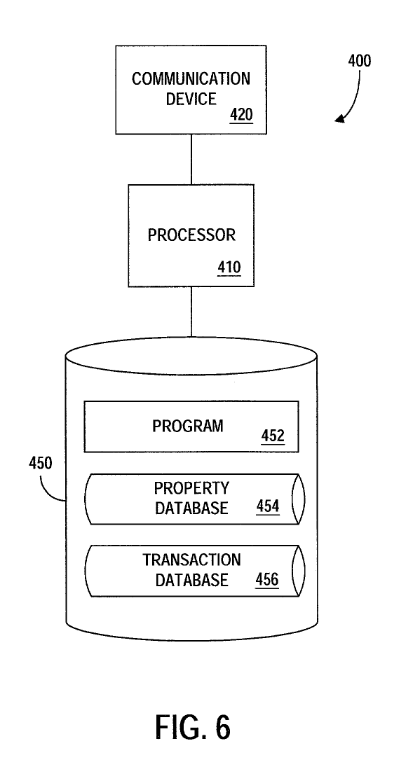

Some or all of the above-mentioned features of embodiments of the present invention may be implemented using one or more computing devices. Reference is now made to FIG. 6 where a transaction device 400 pursuant to some embodiments of the present invention is shown. Transaction device 400 may be associated with one or more of the parties to a transaction conducted pursuant to embodiments of the present invention. For example, transaction device 400 may be operated by or on behalf of a seller, a purchaser, a remainder holder, or a term of years holder. Further, transaction device 400 may be operated by or on behalf of an intermediary to a transaction conducted pursuant to embodiments of the present invention (e.g., by or on behalf of a broker, agent, or the like). Further, several parties to a transaction may each operate transaction devices 400 to consummate a transaction pursuant to embodiments of the present invention.

Transaction device 400 may include a processor 410, such as one or more INTEL Pentium® processors. Processor 410 is coupled to a communication device 420 adapted to communicate via a communication network (not shown). The communication network may be, for example, a Local Area Network (LAN), a Metropolitan Area Network (MAN), a Wide Area Network (MAN), a proprietary network, a Public Switched Telephone Network (PSTN), a wireless network, and/or an Internet Protocol (IP) network such as the Internet, an intranet, or an extranet.

When transaction device 400 is associated with a seller, communication device 420 may be used to communicate, for example, with one or more buyer devices (e.g., operated by or on behalf of an ultimate purchaser or by or on behalf of one or more fractionalized interest holders). As another example, when transaction device 400 is associated with an intermediary, such as a broker, communication device 420 may be used to communicate, for example, with seller devices, purchaser devices, etc. In some embodiments, transaction device 400 is operated by a service provider operating to structure transactions on behalf of parties using techniques of the present invention.

Processor 410 is also in communication with a storage device 430. Storage device 430 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

Storage device 430 stores a program 452 for controlling processor 410. Processor 410 performs instructions of program 452, and thereby operates in accordance with the present invention. Information stored at or accessible to storage device 430 may further include property data (e.g., stored in a property database 454) and transaction data (e.g., stored in a transaction database 456).

The data and programs stored, or accessible to transaction device 400 may be used to facilitate the processing, structuring, and performance of transaction methods pursuant to embodiments of the present invention. As an example, when transaction device 400 is associated with a seller, processor 410 may help to receive information regarding the property, receive assumption and other information from purchasers. Processor 410 may also be used to assist in determining the duration and conditions applicable to any particular common law estate created pursuant to the instant invention or to price and create recombination right(s). For example, processor 410 may operate to generate a number of pricing and structuring scenarios based on different assumptions, allowing the parties to select a structure which generates the greatest potential returns. Transaction device 400 may be utilized to transmit and present these scenarios and terms to each of the parties. In some embodiments, transaction device 400 may be operated to automatically produce deal documentation associated with transactions pursuant to embodiments of the present invention.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method for transferring the equivalent of a common law estate in an asset owned by a first entity, wherein said first entity is obligated to obtain a consent from an interested party if the asset, or a common law estate therein, were directly conveyed to a third party, the method comprising:
forming a disregarded entity holding said first entity's rights in said asset;
transferring a common law estate in the equity interests of such disregarded entity to a subsequent purchaser, wherein said subsequent purchaser acquires the equivalent of a common law estate in the asset, and wherein said transfer does not require consent from any interested party.

2. The method of claim 1, wherein said equivalent is a functional and tax equivalent.

3. The method of claim 1, wherein said asset is real property.

4. The method of claim 1, wherein said disregarded entity is a single member limited liability company.

5. The method of claim 1, wherein said interested party is at least one of: a lender and a tenant.

6. The method of claim 1, further comprising:
converting said first entity into a disregarded entity holding equitable ownership of said asset.

7. The method of claim 1, further comprising forming a second disregarded entity holding all of said first disregarded entity's assets;
wherein said transferring comprises transferring all rights from said second disregarded entity to a subsequent purchaser, wherein said transferring does not require consent from any interested party.

8. A method for transferring the equivalent of a common law estate in an asset owned by a first entity, wherein said first entity is obligated to obtain a consent from an interested party if the asset or a common law estate therein were conveyed directly to a third party, comprising:
forming at least a first disregarded entity to hold all of said first entity's rights in said asset;
transferring a term of years interest in rights of said first disregarded entity to a first purchaser; and
transferring a remainder interest in rights of said first disregarded entity to a second purchaser; and
wherein said transferring is performed without consent of any interested party.

9. A method for transferring the equivalent of a common law estate in an asset owned by a first entity, wherein said first entity is obligated to obtain a consent from an interested party if the asset or a common law estate therein were conveyed directly to a third party, the method comprising:
forming at least a first disregarded entity to hold all of said first entity's rights in said asset;
transferring a term of years interest in rights of said first disregarded entity to a first purchaser;
transferring a remainder interest in rights of said first disregarded entity to a second purchaser; and
transferring a recombination right to said first purchaser allowing said first purchaser to combine said remainder interest with said term of years interest upon payment of an option price;
wherein said transferring is performed without consent of any interested party.

10. A computer-implemented method for transferring a common law estate in an asset or the functional and tax equivalent thereof, comprising:
receiving information identifying said asset or interest;
receiving information identifying at least a first loan secured by said asset or other obligation relating to such asset, said loan or other obligation requiring consent to subsequent transfers of said asset or common law estates therein;
causing the formation of at least a first disregarded entity holding rights to said asset; and
causing to be transferred a common law estate in the equity interests in said disregarded entity that owns such asset to a subsequent purchaser, wherein said transfer of rights does not require any said consent.

11. A computer-readable medium having computer-executable instructions for performing steps comprising:
receiving information identifying at least one of a common law estate in an asset and an equivalent of a common law estate in said asset;
receiving information identifying at least a first loan secured by said asset or other obligation relating thereto, said loan or other obligation requiring consent to subsequent transfers of said asset or interests therein;
causing the formation of at least a first disregarded entity holding rights to said asset; and
causing at least one of a common law estate and an equivalent of a common law estate in the equity interests in said first disregarded entity to be transferred to a subsequent purchaser, wherein said transfer of rights does not require any said consent, wherein said subsequent purchaser acquires at least the functional and tax equivalent of said common law estate in said asset.

12. A computer-implemented method for transferring the functional and tax equivalent of a common law estate in an asset, comprising:
receiving information identifying said asset and rights therein;
receiving information identifying at least a first loan secured by said asset or other obligation relating thereto, said loan or other obligation requiring consent to subsequent transfers of said asset or interests therein;
causing the formation of at least a first disregarded entity holding rights to said asset;
identifying a term of years interest in said rights to said asset or the disregarded entity that owns said asset;
identifying a remainder interest in said rights to said asset or the equity interests in the disregarded entity that owns said asset;
causing said term of years interest to be transferred to a first purchaser; and
causing said remainder interest to be transferred to a second purchaser;
wherein said transfer of said term of years and remainder interests do not require any said consent.

13. The computer-implemented method of claim 11, further comprising:
determining, based at least in part on said first term requiring lender or other consent, whether more than one disregarded entities should be established.

14. A system for causing the transfer of the functional and tax equivalent of a common law estate in an asset, comprising:
means for identifying at least a first loan secured by said asset or other obligation relating thereto, said loan or obligation including a first term requiring consent to subsequent transfers of said asset or interests therein;
means for forming a disregarded entity holding rights to said asset; and
means for causing transfer of a common law estate in the equity interests in said disregarded entity to a subsequent purchaser, wherein said transfer of rights does not require any said consent.

15. The system of claim 14, wherein said at least first disregarded entity is at least one of a single-member limited liability company and a single beneficiary business trust.

16. The system of claim 14, further comprising means for forming a second disregarded entity, said second disregarded entity holding all the equity interests in said first disregarded entity, wherein said means include means for causing the holder of all equity interests in said second disregarded entity to be transferred to a subsequent purchaser, wherein said transfer of rights does not require any said consent.

17. A method for transferring an equivalent of a common law estate in an asset owned by a first entity, wherein a direct transfer of a common law estate in the asset would entail significant transaction costs, the method comprising:
forming a disregarded entity holding said first entity's rights in said asset;
transferring a common law estate in the equity interests of such disregarded entity to a subsequent purchaser, wherein said subsequent purchaser acquires said equivalent of a common law estate in the asset, and wherein said transfer is performed at a substantially lower cost than would be required if a direct transfer of a common law estate in said asset were performed.

18. The method of claim 17, wherein said equivalent of a common law estate in said asset is the functional and tax equivalent of a common law estate in said asset.
